(19) United States
(12) Patent Application Publication
(10) Pub. No.: US 2015/0168901 A1
(43) Pub. Date: Jun. 18, 2015

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Tomomi Yasuda, Kawasaki-shi (JP)

(21) Appl. No.: 14/557,394

(22) Filed: Dec. 1, 2014

(30) Foreign Application Priority Data
Dec. 18, 2013 (JP) 2013-261666

(51) Int. Cl. G03G 15/00

(52) U.S. Cl. CPC G03G 15/5025

(57) ABSTRACT

An image forming apparatus includes: a determination unit configured to determine an adjustment value for outputting a maximum density value determined in advance for a color used in forming an image by an image forming unit; an output unit configured to output a patch image by using an adjustment value determined by the determination unit; a creation unit configured to create a table for correcting a density value of an image formed by the image forming unit by using the results of measuring a patch image output by the output unit; and a control unit configured to control, before the creation unit creates a table, whether or not to cause the determination unit to determine the adjustment value again from the beginning in accordance with a difference between the density value of the patch image and the maximum density value by causing the output unit to output the patch image.

### BACKGROUND OF THE INVENTION

1. Field of the Invention

The present invention relates to a technique for correcting the color tone of an image forming apparatus, such as a printer.

2. Description of the Related Art

In recent years, a color image forming apparatus, such as a color printer and a color copying machine, has been increasingly requested to improve image quality of an output image. It is known that the quality of an image is greatly affected by the stability of the density gradation and color. In particular, in the color image forming apparatus adopting the electrophotographic system, even slight variations in environment will cause variations in density, and therefore, it is necessary to make is possible to keep constant at all times the gradation properties of the density.

Consequently, a conventional color image forming apparatus mounts the so-called calibration function that is performed by a procedure including 1) to 3) below.

1) A chart including patches of data whose gradation is different corresponding to each of toner colors (e.g., CMYK of cyan, magenta, yellow, black) is prepared and output by an image forming apparatus.

2) Values of the output chart are read by using a scanner mounted in the image forming apparatus, or a densitometer independent of the image forming apparatus, or the like.

3) The values read from the chart are compared with target data possessed in advance and thereby an LUT (Look Up Table) for correcting the gradation independently for each of CMYK is created. The LUT is a table indicating output data corresponding to input data divided at specific intervals and it is possible for the LUT to express nonlinear characteristics that cannot be expressed by an arithmetic operation expression. By this LUT, each input signal value of C, M, Y, and K is converted into each output signal value on the image forming apparatus side.

In a process in which such a calibration is performed, it is desirable for the processing from the start of the calibration until the completion thereof to be performed smoothly with no delay. The reason is that the calibration premises that the density characteristics of the printer do not change until the application of a created LUT is completed because in the calibration, the density characteristics of the printer are measured and the LUT for correcting the gradation is created in accordance with the measured density characteristics. Further, the predominant cause of the change in the density characteristics of the printer is the influence of the environment around the printer, such as temperature and humidity, the wear of the working parts caused by the processing to produce a printout, and the consumption of toner. Consequently, it is ideal that the calibration is exclusive from the other pieces of processing of the printer.

However, during a calibration, there is a case where the calibration is delayed on the way because the calibration requires a task of a user.

For example, in a printer in which a scanner is mounted, after the output of a chart is completed, a user needs to take out the chart from the paper eject port of the printer and to place the chart on the scanner. The timing at which the chart is placed on the scanner can be determined at the user's command, and therefore, there can be considered a case where the user forgets the task to place the chart on the scanner and performs a task having nothing to do with the calibration despite the fact that the chart has already been output. In the case where the processing is delayed after the calibration is started due to the reason such as described above, there is a possibility that the density characteristics of the printer will change on the way due to the change in the environment around the printer and the wear of a component in the idle running inside the printer in the idle state.

Further, in the case where a printer in which no scanner is mounted and a PC are connected on a network and a calibration is performed by using a densitometer connected to the PC, a user's task is also necessary to read a chart. Specifically, after the printer starts calibration processing in response to a request from the PC and performs the processing up to producing an output of the chart, a user needs to perform tasks as below.

To go to the position of the printer to take the output chart

To move to a position of measurement with the chart in hand and measure the chart by using a densitometer

To transmit the measurement results from the PC to the printer

There is a possibility that, for example, another user will take the chart away on the way of the above-described task and the chart needs to be output again or the densitometer will be operated wrongly and the measurement needs to be performed again from the beginning.

As described above, there is a possibility that a calibration will be delayed after the start thereof due to various kinds of causes and in the case where the calibration is delayed once, there is a possibility that the density characteristics of the printer will change on the way of the calibration.

Further, in the case of a printer that is used via a network, it can be considered that a calibration is performed under a variety of conditions, such as the way how the printer is operated and the positional relationship between the printer and a PC. Because of this, there is a case where, for example, printing processing is performed even thought a calibration is being performed without making the calibration exclusive from the other pieces of job processing in view of the influence of downtime on another user during the calibration. In this case, in addition to the possibility of the previously-described delay due to the interposition of a user's task, there is a possibility that the density characteristics will change more considerably due to the consumption of toner, the wear of a component that is used, etc., resulting from the printing processing performed during the calibration.

Various techniques have been proposed in order to solve the problem such as described above that a calibration cannot be completed appropriately because of the change in the density characteristics of a printer during the calibration. For example, Japanese Patent Laid-Open No. H11-179969 (1999) has disclosed a technique in which the time at which a chart is output and the time at which the chart is read are compared and in the case where a fixed time or more has elapsed after the chart is output, parameter generation processing is prohibited.

In the technique disclosed in Japanese Patent Laid-Open No. H11-179969 (1999), whether or not there is a change in the density characteristics of the image forming apparatus during a calibration is determined in a simple manner based on the elapsed time after the chart is output. It is true that the possibility of the occurrence of a change in the density characteristics becomes greater in the case where the elapsed time is longer. However, in many cases, the predominant causes of the change in the density characteristics are use conditions, such as the contents of printed matter, the number of sheets on which printing processing has been performed, and the amount of consumed toner, a change in the peripheral environment, such as temperature and humidity, etc.

Consequently, in the case where whether or not there is a change in the density characteristics is determined based on only the elapsed time, there may happen that a calibration is aborted even though there is no change in the density characteristics actually and a parameter to be obtained originally is not generated. This will cause a user to perform the calibration again from the beginning and increase the burden of a task on the user. Further, there can be considered a case where even though there is a change in the density characteristics actually, a calibration is not performed because the elapsed time is short, and therefore, an appropriate parameter is not obtained. As described above, the method disclosed in Japanese Patent Laid-Open No. H11-179969 (1999) in which whether or not it is necessary to perform a calibration is determined based on only the elapsed time has such problems that the burden of a task on a user is increased and that a sufficient image quality is not guaranteed.

### SUMMARY OF THE INVENTION

An image forming apparatus according to the present invention comprises: a determination unit configured to determine an adjustment value for outputting a maximum density value determined in advance for a color used in forming an image by an image forming unit; an output unit configured to output a patch image by using an adjustment value determined by the determination unit; a creation unit configured to create a table for correcting a density value of an image formed by the image forming unit by using the results of measuring a patch image output by the output unit; and a control unit configured to control, before the creation unit creates a table, whether or not to cause the determination unit to determine the adjustment value again from the beginning in accordance with a difference between the density value of the patch image and the maximum density value by causing the output unit to output the patch image.

According to the present invention, it is possible to prevent an unnecessary calibration from being performed again from the beginning while guaranteeing image quality at the time of the completion of a calibration.

Further features of the present invention will become apparent from the following description of exemplary embodiments (with reference to the attached drawings).

### BRIEF DESCRIPTION OF THE DRAWINGS

FIG. 1 is a diagram showing an internal configuration of an image forming apparatus having a calibration function according to a first embodiment;

FIG. 2 is a diagram for explaining internal processing of an image processing unit;

FIG. 3 is a schematic diagram showing an input/output relationship of a 1D-LUT correction unit;

FIG. 4 is a flowchart showing a flow of calibration control processing in the image forming apparatus according to the first embodiment;

FIG. 5 is a flowchart showing a flow of detailed processing of maximum density adjustment processing;

FIG. 6 is a flowchart showing details of chart printing processing;

FIG. 7 is a flowchart showing details of maximum density check processing;

FIG. 8 is a flowchart showing details of density characteristics change determination processing;

FIG. 9 is a graph indicating a relationship between the halftone target and the actually measured value;

FIG. 10 is a flowchart showing details of calibration table creation processing;

FIG. 11 is a flowchart showing a flow of calibration control processing in an image forming apparatus according to a second embodiment;

FIG. 12 is a flowchart showing a flow of calibration control processing in an image forming apparatus according to a third embodiment;

FIG. 13 is a flowchart showing details of change direction determination processing;

FIG. 14 is a flowchart showing details of calibration table correction processing; and

FIG. 15 is a graph indicating a relationship between the calibration table before correction and the calibration table after correction.

### DESCRIPTION OF THE EMBODIMENTS

Hereinafter, embodiments of the present invention are explained by using the drawings. In the present specification, an example of processing to perform a calibration in an image forming apparatus adopting the electrophotographic system, which includes toner in four colors of CMYK and performs color printing is explained. However, it is also possible to apply the present invention to other recording methods, such as an inkjet recording method, or to an image forming apparatus performing monochrome printing using only one color (K).

### First Embodiment

### Configuration of Image Forming Apparatus

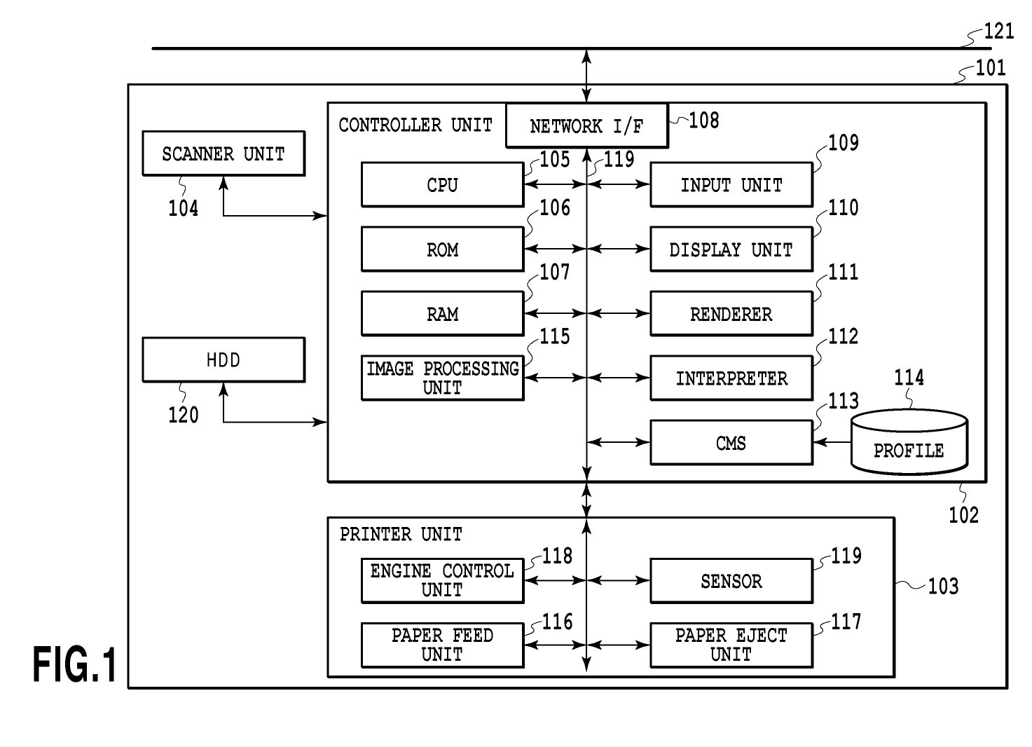

FIG. 1 is a diagram showing an internal configuration of an image forming apparatus having a calibration function according to the present embodiment.

An image forming apparatus 101 includes a controller unit 102, a printer unit 103, a scanner unit 104, and an HDD 120.

The controller unit 102 includes various kinds of modules, such as a CPU 105, and each module is connected to one another via a data bus 121. A RAM 107 loads program data stored in a ROM 106 and temporarily stores the program data. Then, the CPU 105 gives a command to each module in accordance with the program loaded on the RAM 107 and causes the image forming apparatus 101 to operate. Data etc. generated at the time of each module executing a command is also stored temporarily in the RAM 107.

A network I/F 108 is an interface module with a network 121. For example, the network I/F 108 performs data communication, such as communication with another device via the network 121 based on a communication protocol, such as Ethernet (registered trademark), reception of print data, etc.

An interpreter 112 interprets the PDL (Page Description Language) portion of the received print data and generates intermediate language data.

A CMS (Color Management System) 113 performs color conversion processing on the intermediate language data generated in the interpreter 112 by using a profile 114 stored in the ROM 106. The profile 114 includes a source profile and a destination profile, not shown. By performing the color conversion processing, the color space of an input device is converted into the color space of an output device (image forming apparatus 101).

A renderer 111 generates raster image data from the intermediate language data having been subjected to the color conversion processing (hereinafter, post CMS intermediate language data).

An image processing unit 115 performs predetermined image processing on the raster image data generated in the renderer 111.

A display unit 110 includes a liquid crystal display etc. for displaying various kinds of information, such as instructions to a user and the state of the image forming apparatus 101. The display unit 110 may have a touch screen function. In such a case, it is also possible to handle user's instructions given via a touch screen as an input of an input unit 109.

The input unit 109 is an interface for receiving an input from a user.

The printer unit 103 performs printing processing to form image data on a printing medium, such as paper, by using colored toner, such as C, M, Y, and K toner. The printer unit 103 has a paper feed unit 116 configured to feed paper and a paper eject unit 117 configured to eject printed paper etc. besides an engine control unit 118 configured to control a printer engine. Further, on an intermediate transfer belt (not shown) of the printer unit 103, a sensor 119 capable of measuring the density of at least a developed image is provided and the measured density (numerical value information) is sent to the controller unit 102.

The scanner unit 104 irradiates a bundle of documents or one document set on a document table or an ADF (not shown) by a light source, and forms a reflected image by a lens on a solid-state image capturing element, such as a CCD sensor, and obtains a signal of a read image in the form of a raster as image data from the solid-state image capturing element.

The HDD 120 is a storage device for storing various kinds of parameters etc. used in the image forming apparatus 101. The HDD 120 is connected with the controller unit 102 and the above-described LUT used in a 1D-LUT correction unit 202, parameters used at the time of output in the above-described engine control unit 118, etc., are stored or read in accordance with necessity.

Next, details of the processing in the image processing unit 115 are explained.

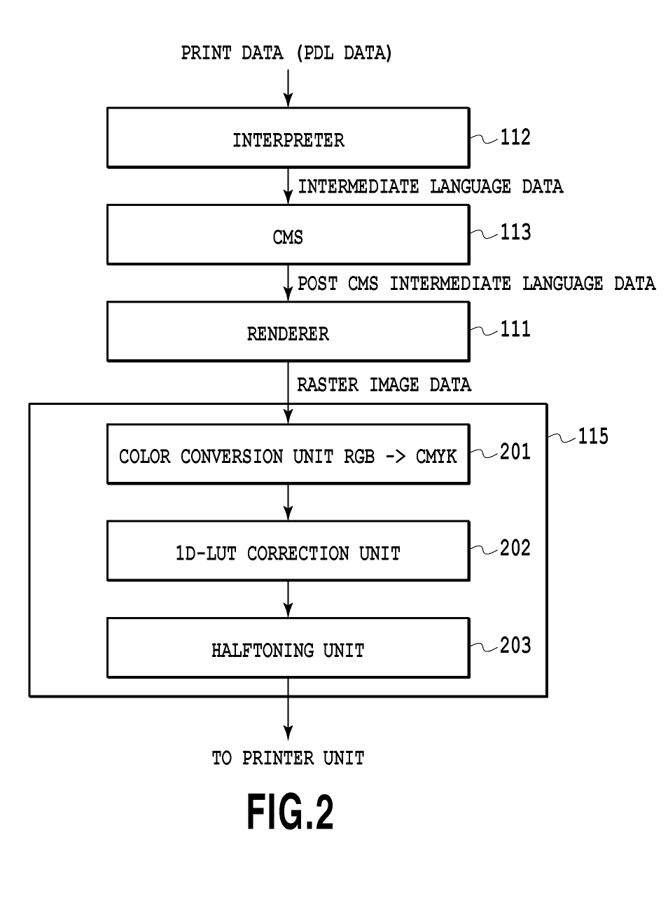

FIG. 2 is a diagram for explaining the processing inside the image processing unit 115. Print data (PDL data) input to the image forming apparatus 101 turns into raster image data through each piece of the processing in the interpreter 112, the CMS 113, and the renderer 111 and is input to the image processing unit 115.

The image processing unit 115 includes a color conversion unit 201, the 1D-LUT correction unit 202, and a halftoning unit 203.

The color conversion unit 201 is a processing unit configured to perform conversion into the color space of CMYK in the case where the data output from the CMS 113 is data in the device-dependent RGB color space. In the case where the data output from the CMS 113 is the data in the device-dependent CMYK color space, the processing in the color conversion unit 201 is skipped.

The 1D-LUT correction unit 202 corrects the gradation of each single color of C, M, Y, and K of the CMYK data whose color space has been converted in the color conversion unit 201 and converts each into C2, M2, Y2, and K2, respectively. In this case, on a condition that the input signal of the 1D-LUT is 8-bit data, preferably, the number of entries in the LUT is 256. In other words, preferably, one output value is stored for each of all the input values 0 to 255.

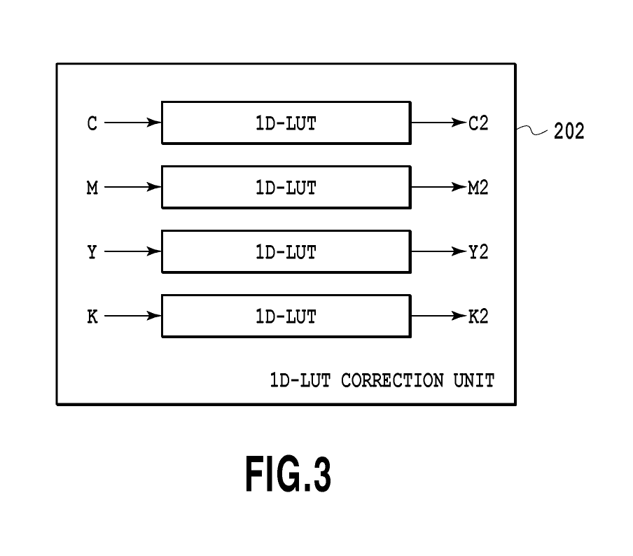

FIG. 3 is a schematic diagram showing the input/output relationship of the 1D-LUT correction unit 202. In FIG. 3, four 1D-LUTs for C input/C2 output, M input/M2 output, Y input/Y2 output, and K input/K2 output are independent of one another and one output exists for one input.

The halftoning unit 203 performs screen processing by using a dither pattern etc. on the data of C2, M2, Y2, and K2 output from the 1D-LUT correction unit 202. Then, the image data on which the screen processing has been performed is sent to the printer unit 103 and is printed on a sheet.

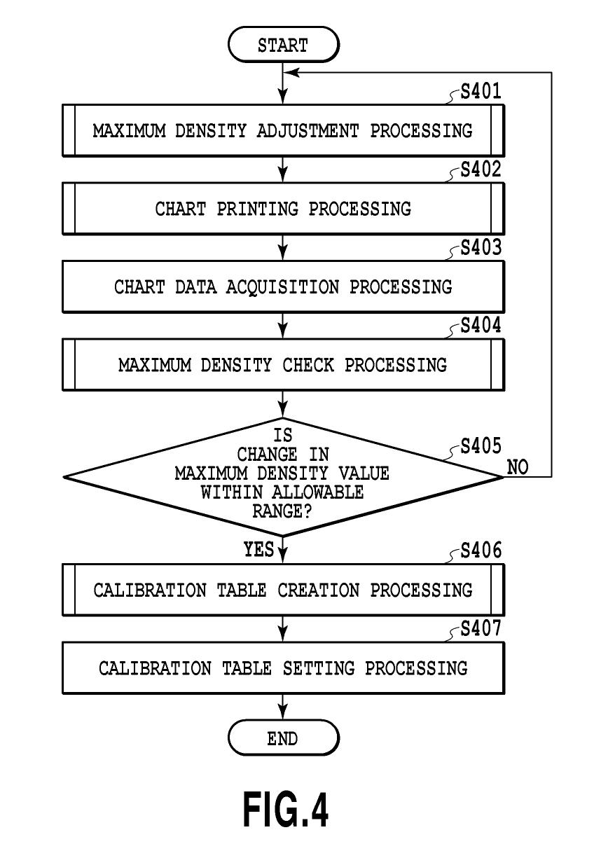

FIG. 4 is a flowchart showing a flow of calibration control processing in the image forming apparatus 101 according to the present embodiment. The series of the processing is performed by the CPU 105 executing computer-executable programs in which the procedures shown below are described after reading the programs from the ROM 106 onto the RAM 107. Hereinafter, each piece of the processing constituting the calibration control processing according to the present embodiment is explained along the flowchart in FIG. 4.

### (Maximum Density Adjustment Processing)

Upon receipt of a user's operation to give instructions to perform a calibration (automatic gradation correction) via a UI screen, not shown, displayed on the display unit 110, the controller unit 102 performs processing to adjust the maximum density at step 401. The maximum density adjustment processing is processing to set a parameter (maximum density parameter (prmMaxD)) related to a laser voltage value, which makes it possible to output a maximum density target value (tgtMaxD) that is set for each toner color on a sheet having a certain basis weight. Here, the maximum density target value and the maximum density parameter are explained.

The maximum density target value (tgtMaxD) is a constant density value set for each toner color in advance as the maximum density that is output onto a sheet having any basis weight. For example, in the case where the image forming apparatus 101 forms an image by using toner in four colors, cyan (C), magenta (M), yellow (Y), and black (B), the four maximum density target values exist as a result. In this case, in the order of cyan, magenta, yellow, and black, maximum density target values, such as C-tgtMaxD, M-tgtMaxD, Y-tgtMaxD, and K-tgtMaxD, are stored in the ROM 106.

The maximum density parameter (prmMaxD) is a parameter set for each toner color in order to output the target maximum density onto a sheet having any basis weight in the development process of the image forming apparatus 101. For example, in the case where the image forming apparatus forms an image by using toner in the colors of cyan (C), magenta (M), yellow (Y), and black (K), the four maximum density parameters exist as a result. In this case, maximum density parameters, such as C-prmMaxD, M-prmMaxD, Y-prmMaxD, and K-prmMaxD, are stored in the HDD 120.

An outline of a flow of the maximum density adjustment processing is as 1) to 3) below.

1) For each toner color, a plurality of parameters related to the laser voltage value is prepared as maximum density parameter candidate values (cddMaxD). Here, the maximum density parameter candidate value (cddMaxD) is a parameter used at the time of searching for a maximum density parameter. The maximum density parameter candidate value is set for each toner color and each toner color has an arbitrary number of candidate values. For example, in the case where there exist n maximum density parameter candidate values for cyan, values determined in advance, such as C-cddMaxD1, C-cddMaxD2, C-cddMaxD3, . . . , C-cddMaxDn, are stored in the ROM 106 in advance.
2) A patch is output in the printer unit 103 by using the maximum density parameter candidate values (cddMaxD) and the density of the patch is measured by using the sensor 119.
3) The patch that exhibits the same density value as the above-described maximum density target value of the density values obtained by the measurement is specified and the maximum density parameter candidate value used in outputting the specified patch is set as the maximum density parameter (prmMaxD).

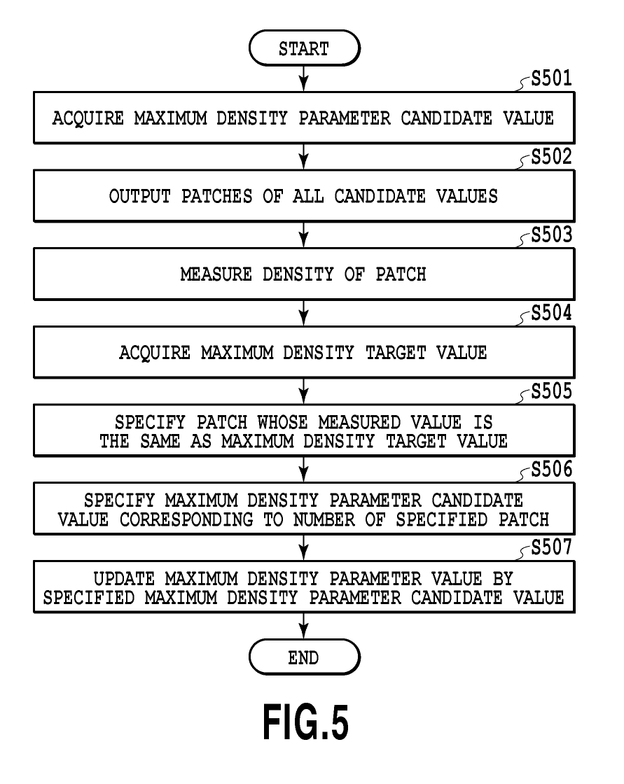

FIG. 5 is a flowchart showing a flow of the detailed processing of the maximum density adjustment processing.

At step 501, the CPU 105 refers to the maximum density parameter candidate values stored in the ROM 106 and acquires the maximum density parameter candidate values in the number corresponding to the total number of toner colors. The acquired maximum density parameter candidate values are sent to the engine control unit 118.

At step 502, the engine control unit 118 causes the printer unit 103 to operate and to print patches corresponding to all the candidate values of the received maximum density parameter candidate values on an intermediate belt.

At step 503, the engine control unit 118 causes the sensor 119 to operate to measure the density of each patch. Measured density values (D1, D2, D3, . . . , Dn) of each patch are stored temporarily in the RAM 107. For example, as to cyan, measured density values, such as C-D1, C-D2, C-D3, . . . , and C-Dn, are stored in the RAM 107 for each toner color.

At step 504, the CPU 105 acquires the maximum density target values (tgtMaxD) stored in the ROM 106 in the number corresponding to the number of toner colors and stores the maximum density target values in the RAM 107.

At step 505, the CPU 105 compares the maximum density target values (tgtMaxD) stored in the RAM 107 and the measured density values (D1, . . . , Dn) of each patch. Then, the patch with the measured value (Dn) the same as (or closest to) the maximum density target value is searched for and specified for each toner color. Then, the number (max_pnum) of the specified patch is stored in the RAM 107. For example, a patch whose measured density value (C-Dx) is the same as the maximum density target value (C-tgtMaxD) of cyan is specified and the patch number (C-max_pnum) is stored in the RAM 107.

At step 506, the CPU 105 refers to the patch numbers (max_pnum) stored in the RAM. 107 and specifies a parameter with the same number of the maximum density parameter candidate values (prmMaxD). For example, in the case where the patch number (C-max_pnum) of the specified patch of cyan is 3, the third maximum density parameter candidate value (C-cddMaxD3) is specified.

At step 507, the CPU 105 overwrites the value of the maximum density parameter (prmDmax) stored in the HDD 120 by the value of the maximum density parameter candidate value (cddMaxDx) specified at step 506. After completing the updating of the values of the maximum density parameters (prmDmax) of all the toner colors, the present processing is exited.

The above is the contents of the maximum density adjustment processing.

### (Chart Printing Processing)

At step 402, the controller unit 102 performs chart printing processing. The chart printing processing is processing to output a chart for measuring the halftone characteristics of the image forming apparatus 101 after the value of the maximum density parameter (prmDmax) has been updated in the above-described maximum density adjustment processing. In outputting a chart, dedicated image data (calImg) is used. Here, chart image data is explained. The chart image data is raster image data having a plurality of gradation values for each toner color and is stored in advance in the ROM 106. For example, in the case of a chart having t gradation values (grd), the chart image data has each of values, such as C-grd1, C-grd2, C-grd3, . . . , C-grdt, for cyan. Then, there exist patch numbers (grd_pnum) corresponding to the gradation values, respectively, on the chart image data. In the case where a chart has t gradation values, the t patch numbers in the same number as that of the gradation value exist and, for example, to the first gradation value (C-grd1) of cyan, a first patch number (C-grd_pnum1) of cyan corresponds. The patch number such as this is associated in advance with position information (loc_grd_pnum) indicative of coordinates of the patch on the chart and, for example, the first patch number (C-grd_pnum1) of cyan is associated with position information (C-loc_grd_pnum1). Both the patch number and the position information are stored in the ROM 106.

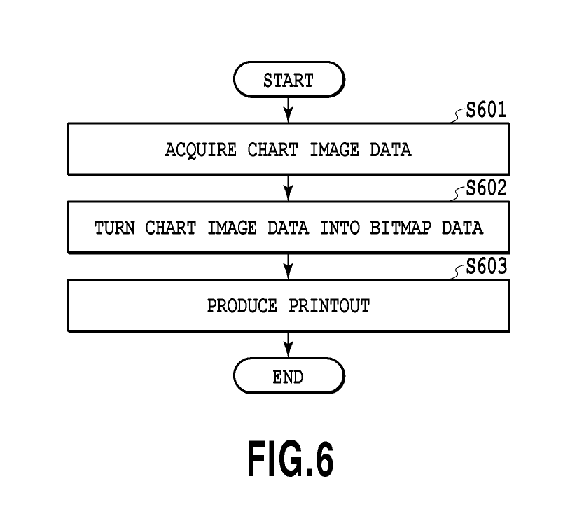

FIG. 6 is a flowchart showing details of the chart printing processing.

At step 601, the CPU 105 acquires the chart image data (calImg) stored in the ROM 106. The acquired chart image data is stored in the RAM 107 and then is sent to the image processing unit 115.

At step 602, the image processing unit 115 performs halftone processing, such as dither, on the received chart image data to turn the chart image data into bitmap data. The chart image data (haltone_calImg) having been turned into bitmap data is stored in the RAM 107.

At step 603, the CPU 105 sends the chart image data having been turned into bitmap data to the engine control unit 118 and gives instructions to perform printing. Upon receipt of the instructions, the engine control unit 118 forms an image on a sheet fed from the paper feed unit 116 by using the received chart image data having been turned into bitmap data and ejects the sheet to the paper eject unit 117. After the chart is ejected by the paper eject unit 117, the CPU 105 exits the present processing.

The above is the contents of the chart printing processing.

The maximum density adjustment processing at step 401 and the chart printing processing at step 402 are performed substantially at the same time.

### (Chart Data Acquisition Processing)

At step 403, the controller unit 102 acquires the data of density value obtained by measuring the patch on the printed and output chart. Prior to the acquisition of the density value data obtained by measuring the chart, a user sets the chart in the scanner unit 104 and gives instructions to read the chart. By the acquisition of the data, it is possible to know the halftone characteristics of the image forming apparatus 101 after the value of the maximum density parameter (prmDmax) has been updated. The acquired density value data is stored in the RAM 107 as chart data (chrtD). For example, in the case of the density value data obtained by measuring the patch of cyan, density values, such as C-chrtD1, C-chrtD2, C-chrtD3, . . . , C-chrtDi, in the number corresponding to the number of patches are stored in the RAM 107. In this case, the chart data is associated with the gradation value of the patch on the chart, such as, for example, the gradation value (C-grd1) of the patch number (C-grd_pnum1) of cyan is associated with measured data (C-chrtD1).

### (Maximum Density Check Processing)

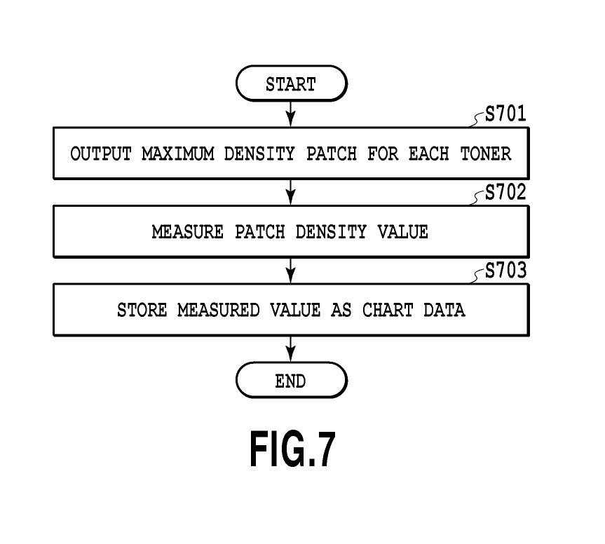

At step 404, the controller unit 102 performs maximum density check processing. The maximum density check processing is processing for determining in a simple manner whether there is a difference between the density characteristics after the maximum density adjustment processing at step 401 and the density characteristics at the time of the acquisition of the chart data. FIG. 7 is a flowchart showing details of the maximum density check processing.

Prior to the start of the maximum density check processing, an area in which the density value (jdgD) of the patch that will be obtained by this processing is stored is secured on the RAM 107.

At step 701, the CPU 105 gives the maximum gradation value of each color to the engine control unit 118 and gives instructions to output the patch. Upon receipt of the instructions, the engine control unit 118 outputs one patch of the maximum gradation value on an intermediate belt for each toner color.

At step 702, the CPU 105 gives instructions to measure the output patch to the engine control unit 118. Upon receipt of the instructions, the engine control unit 118 causes the sensor 119 to operate to measure the density value (jdgD) of the patch for each toner color.

At step 703, CPU 105 stores the measured density value (jdgD) within the area of the RAM 107 secured in advance. For example, the density value is stored for each toner color, such as that the density value of the patch of cyan is stored as C-jdgD, that of magenta as M-jdgD, that of yellow as Y-jdgD, and that of black as K-jdgD.

The above is the contents of the maximum density check processing.

### (Density Characteristics Change Determination Processing)

At step 405, the controller unit 102 determines whether the density value of each color obtained by the maximum density check processing has changed from the maximum density target value. Specifically, a difference between the obtained density value (jdgD) and the maximum density target value (tgtMaxD) is found and whether the difference that is found is within a range of a change allowable threshold value (allowDdiff) is determined. Here, the change allowable threshold value is a threshold value used to determine the presence/absence of a change in the density characteristics and a value set in advance is stored in the ROM 106 as the change allowable threshold value.

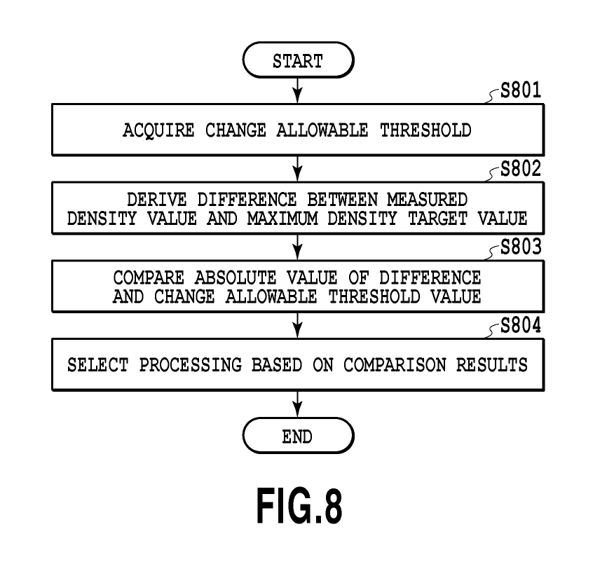

FIG. 8 is a flowchart showing details of the density characteristics change determination processing.

At step 801, the CPU 105 acquires the change allowable threshold value (allowDdiff) from the ROM 106. The acquired change allowable threshold value is stored in the RAM 107.

At step 802, the CPU 105 finds a difference (difftgtD) between the density measured value (jdgD) and the maximum density target value (tgtMaxD) stored in the RAM 107 for each toner color by using both the values. The difference between both the values is found as a value obtained by subtracting the density measured value (jdgD) from the maximum density target value (tgtMaxD). The absolute value (absdifftgt) of the difference that has been found is further found and the difference (difftgtD) and the absolute value (absdifftgt) are stored in the RAM 107.

At step 803, the CPU 105 compares the absolute value of the difference and the change allowable threshold value. The results of the comparison (diffcmp) are stored in the RAM 107 for each toner color. For example, in the case where the absolute value of the difference is smaller than the change allowable threshold value, a value of 1 is stored as the comparison results and in the case where the absolute value of the difference is greater than the change allowable threshold value, a value of 0 is stored as the comparison results.

At step 804, the CPU 105 determines processing to be performed next based on the comparison results for all the toner colors. Specifically, in the case where the absolute value of the difference is smaller than the change allowable threshold value for all the toner colors (in the above-described example, all the comparison results (difcmp) are 1), the processing proceeds to processing to create a calibration table (step 406). On the other hand, in the case where there exists a color for which it has been determined that the absolute value of the difference is greater than the change allowable threshold value (in the above-described example, the comparison results (difcmp) are 0), the processing returns to the maximum density adjustment processing at step 401.

The above is the contents of the density characteristics change determination processing.

### (Calibration Table Creation Processing)

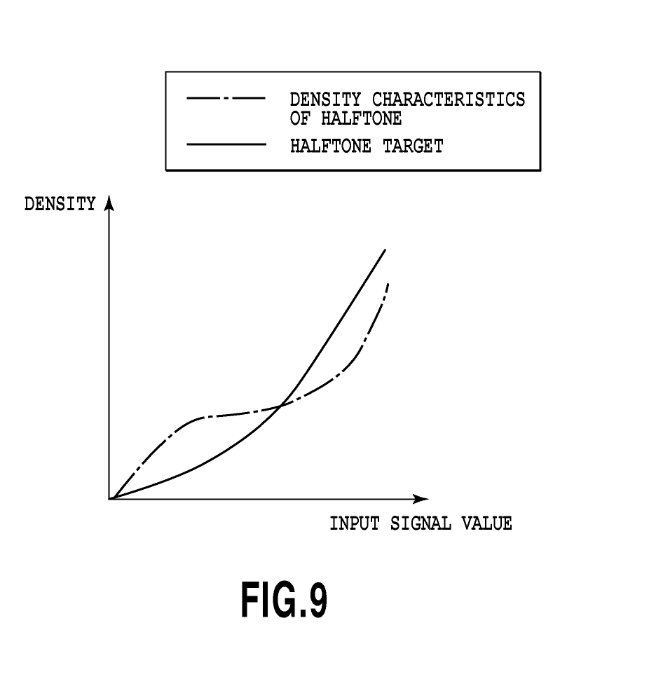

At step 406, the controller unit 102 creates a calibration table (calLUT) for each toner color. As described previously, the calibration table is an LUT for correcting the input gradation value in the 1D-LUT correction unit 202 and is a table having information on the output gradation value for the input gradation value. Based on this calibration table, the input gradation value is corrected so that the relationship between the density value of each patch obtained by measuring the chart and the gradation value of each patch will be the same as the relationship between the input gradation value and the output density value in a target table (tgtLUT). Here, the target table is an LUT indicating a target value of the density desired to be output on a sheet in the case where a certain input gradation value is input to the 1D-LUT correction unit 202 and is set for each toner color and stored in the ROM 106 in advance. FIG. 9 is a graph indicating the relationship between the halftone target and the actually measured value where the horizontal axis represents the input gradation value (input signal value) and the vertical axis represents the actual density value. In the graph in FIG. 9, the solid line indicates the output density value for the input gradation value in the target table and the alternate long and short dash line indicates the measured density value for the input gradation value of each patch.

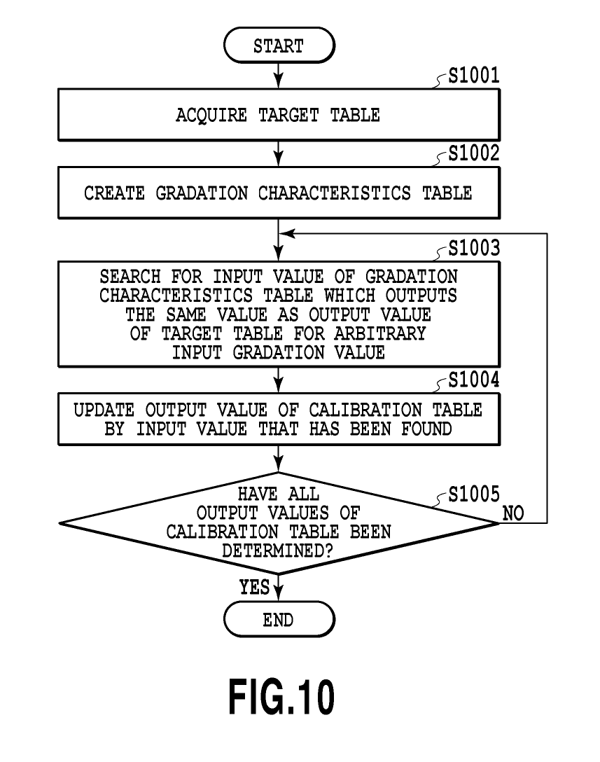

FIG. 10 is a flowchart showing details of the calibration table creation processing.

At step 1001, the CPU 15 acquires the target table (tgtLUT) from the ROM 106. The acquired target table is stored in the RAM 107.

At step 1002, the CPU 105 creates a gradation characteristics table (grdLUT) for each of all the toner colors by using the gradation value (grd) of the patch of the chart and the measured density value (chrtD) stored in the RAM 107. Here, the gradation characteristics table is an LUT having density values for input gradation values at certain intervals as output values. The created gradation characteristics table is stored in the RAM 107.

At step 1003, the CPU 105 searches for an input value (input_grdLUT) of the gradation characteristics table which outputs the same value as an output value (out_tgtLUT) of the target table for an arbitrary input gradation value (inputData).

At step 1004, the CPU 105 updates the output value of the calibration table (calLUT) at the time of an arbitrary input gradation value by the value of the input value (input_grdLUT) that has been found in the search. In this case, the number of input gradation values (inputData) will be 16 on a condition that, for example, the value area (0 to 255) of the 8-bit gradation value is divided by a gradation width of 15.

At step 1005, the CPU 105 determines whether the output values for all the input values of the calibration table have been determined. In the case where there is an output value that has not been determined yet, the processing returns to step 1003 and the processing is repeated until all the output values are determined. The completed calibration table is stored in the RAM 107.

After the calibration tables (calLUT) in the number corresponding to the number of toner colors are created, the present processing is exited.

The above is the contents of the calibration table creation processing.

### (Calibration Table Setting Processing)

At step 407, the controller unit 102 stores (overwrites) the calibration tables in the number corresponding to the number of toner colors stored in the RAM in (on) the HDD 120. Due to this, a state is brought about where the calibration table can be used in the 1D-LUT correction unit 202.

It is also possible to similarly perform the above-described calibration control processing in an image forming apparatus capable of receiving a calibration request from an external control device, such as a PC, connected via a network. In the chart data acquisition processing (step 403) in this case, the density value of the chart is measured by a densitometer etc. connected to the PC and the measurement results (chrtD) sent via the network are stored in the RAM 107 as the measured density value.

As above, according to the present embodiment, at the time of the acquisition of the chart data, the changed state of the density characteristics is checked and control is performed so that in the case where the change exceeds the allowable range, the calibration is performed again from the beginning. Due to this, the image quality at the time of the completion of the calibration is guaranteed. On the other hand, in the case where the change in the density characteristics is within the allowable range, the calibration is continued, and therefore, it is possible to avoid the calibration from being performed unnecessarily again from the beginning.

### Second Embodiment

In the first embodiment, the maximum density check processing is performed for each calibration. Next, an aspect is explained as a second embodiment, in which the possibility that the density characteristics have changed is examined and the maximum density check processing is performed only in the case where the possibility is equal to or greater than a fixed value. Explanation of the portions in common to those of the first embodiment is omitted or simplified and different points are explained mainly.

In the present embodiment, by taking into consideration the possibility that the progress of the calibration will be delayed during the processing including the chart data acquisition processing and the preceding processing, the possibility that the density characteristics have changed is determined before the maximum density check processing. Specifically, whether a phenomenon that will cause the change in density has occurred during the calibration is determined based on factors, such as the peripheral environment, for example, temperature and humidity around the image forming apparatus, the number of sheets on which printing processing has been performed, and the amount of consumed toner.

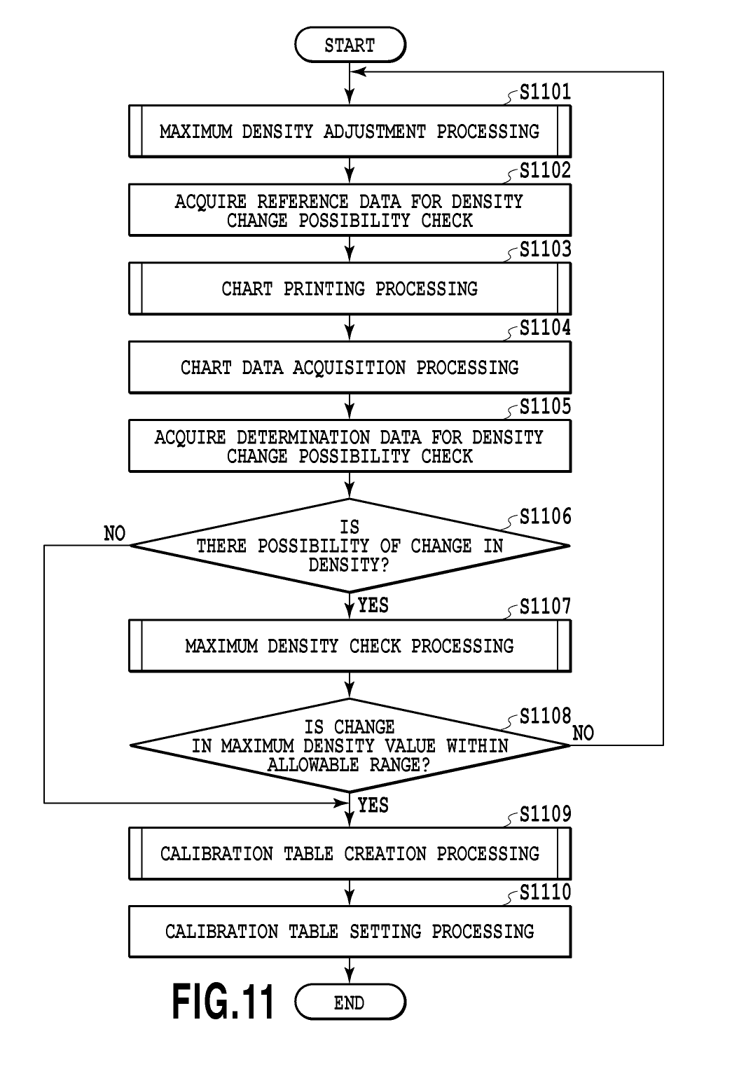

FIG. 11 is a flowchart showing a flow of the calibration control processing in the image forming apparatus 101 according to the present embodiment. The series of the processing is performed by the CPU 105 executing computer-executable programs in which the procedures shown below are described after reading the programs from the ROM 106 onto the RAM 107. Hereinafter, along the flowchart in FIG. 11, each piece of processing constituting the calibration control processing according to the present embodiment is explained.

Upon receipt of a user's operation to give instructions to perform a calibration (automatic gradation correction) via a UI screen, not shown, displayed on the display unit 110, the controller unit 102 performs processing to adjust the maximum density at step 1101.

After adjusting the maximum density, the controller unit 102 acquires data used as a reference for determining the possibility of the change in density at step 1102. For example, the controller unit 102 measures temperature/humidity by an environmental sensor, not shown, acquires the counter value of the counter for counting the number of sheets on which printing processing has been performed, acquires the time of the completion of the maximum density adjustment processing, and so on. The acquired reference data such as this is stored in the RAM 107 as temperature (bf_tmpr), humidity (bf_hmdt), a counter value (bf_prcon), a time (bf_time), etc.

Step 1103 and step 1104 are the same as step 402 and step 403 in the flowchart in FIG. 4 according to the first embodiment.

After acquiring the chart data at step 1104, the controller unit 102 acquires data for checking the presence/absence of the possibility of the change in the density characteristics at step 1105. Specifically, the controller unit 102 acquires data for determination (hereinafter, determination data) corresponding to each item of the reference data acquired at step 1102. In the case of the above-described example, the temperature, humidity, counter value, and time at the point of time immediately after the acquisition of the chart data are acquired and temperature (af_tmpr), humidity (af_hmdt), a counter value (af_prcon), and a time (af_time) are stored in the RAM 107 as determination data.

At step 1106, the controller unit 102 performs processing to determine the presence/absence of the possibility of the change in the density characteristics (change possibility determination processing) by using the above-described reference data and determination data. Specifically, by a procedure as follows, whether a phenomenon that will cause the change in density has occurred during the calibration is determined. First, a threshold value corresponding to each item of the reference data and the determination data is acquired. In the case of the above-described example, each of a temperature change allowable threshold value (allow_tmpr), a humidity change allowable threshold value (allow_hmdt), an output sheet number allowable threshold value (allow_prcon), and an elapsed time allowable threshold value (allow_time) is acquired. These threshold values may be set in advance by a user and stored in the ROM 106 etc. After this, a difference between each piece of the reference data and each piece of the determination data is found and whether the difference that has been found exceeds each threshold value is determined. For example, a difference (absolute value) between the temperature (bf_tmpr) as the reference data and the temperature (af_tmpr) as the determination data is calculated and whether the calculated difference exceeds the temperature change allowable threshold value (allow_tmpr) is determined. In the case where it is determined that the difference that has been found exceeds the threshold value for any one of the items, the processing proceeds to the maximum density check processing (step 1107) because there is a possibility of the change in density. On the other hand, in the case where it is determined that the difference that has been found does not exceed the threshold value for all the items, the maximum density check processing is skipped and the processing proceeds to the calibration creation processing (step 1109) because there is no possibility of the change in density.

Each piece of the processing at step 1107 and subsequent steps is the same as each piece of the processing in the flowchart in FIG. 4 according to the first embodiment, and therefore, explanation is omitted.

By the processing as above, the maximum density check processing is performed only in the case where the possibility of the change in the density characteristics is equal to or greater than a fixed value, and therefore, it is made possible to reduce downtime.

According to the present embodiment, in the case where it is determined that the possibility of the change in the density characteristics is faint, the maximum density is not checked, and therefore, it is possible to prevent user's work efficiency from reducing while guaranteeing the image quality at the time of the completion of calibration.

### Third Embodiment

In the case where a calibration table is created despite the fact that the density characteristics have changed, the completed calibration table will be one that corrects the state before the density characteristics have changed. With such a calibration table, it is not possible to output the gradation of the target table (tgtLUT), and therefore, in the first and second embodiments, in the case where the amount of change in the density characteristics is equal to or more than a fixed amount, the maximum density adjustment processing is performed again from the beginning. On the other hand, in the case where the calibration is performed again from the maximum density adjustment processing, because the time required to complete the calibration increases, the time a user has to spend increases and at the same time, the amount of toner and the number of sheets that are used in the processing also increase, and therefore, the burden on the user will be great. Consequently, an aspect is explained as a third embodiment, in which even in the case where a change in the density characteristics by an amount equal to or greater than a fixed amount is recognized, on a condition that it is possible to deal with the change by correcting the calibration table, the maximum density adjustment processing is not performed again. Explanation of the portions in common to those of the first embodiment is omitted or simplified and different points are explained mainly.

In the present embodiment, even in the case where a change in the density characteristics by an amount equal to or more than a fixed amount is recognized, on a condition that it is possible to output a density equal to or greater than the maximum density target value (tgtMaxD), the maximum density adjustment processing is not performed again but the calibration table is corrected to deal with the change. In the case where it is not possible to output a density equal to or greater than the maximum density target value, the change is not dealt with by correcting the calibration table because it is not possible to output the value of the target table, which will implement the gradation of the high density part, in the state where the maximum density target value cannot be output even by correcting the calibration table. Because of this, in the case where a change in the density characteristics by an amount equal to or more than a fixed amount is recognized and it is determined that a density equal to or more than the maximum density target value cannot be output, the calibration processing needs to be performed again from the maximum density adjustment processing.

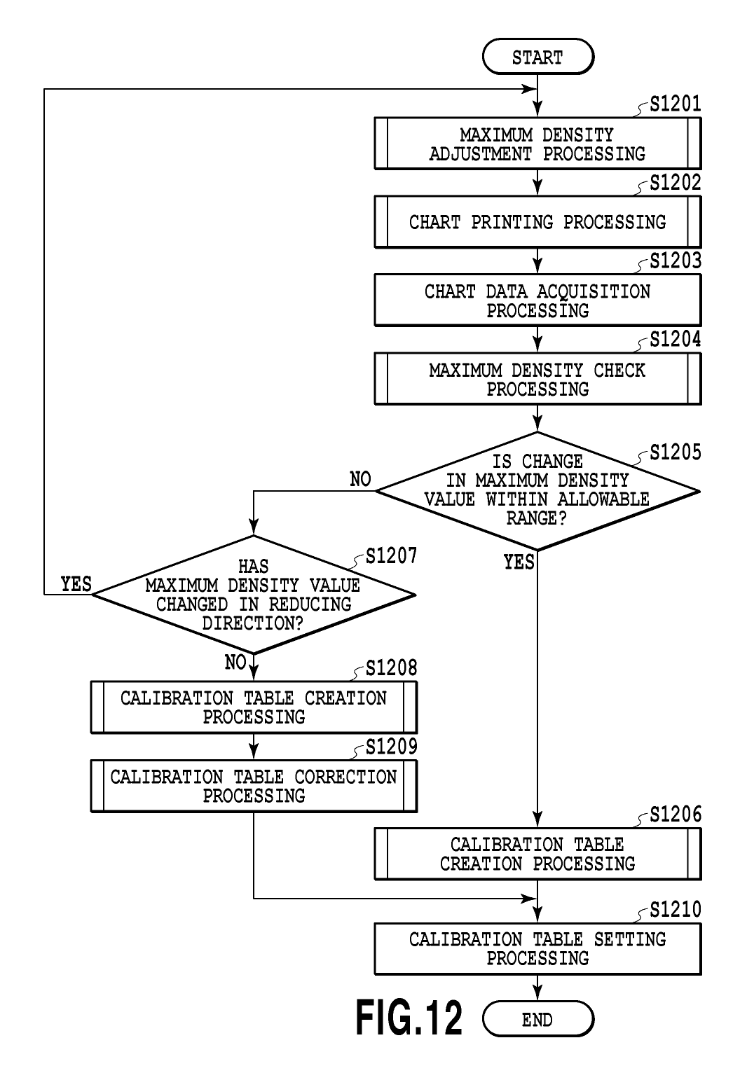

FIG. 12 is a flowchart showing a flow of calibration control processing in the image forming apparatus 101 according to the present embodiment. The series of the processing is performed by the CPU 105 executing computer-executable programs in which the procedures shown below are described after reading the programs from the ROM 106 onto the RAM 107. Hereinafter, each piece of processing constituting the calibration control processing according to the present embodiment is explained along the flowchart in FIG. 12.

The processing from the processing immediately after the reception of the user's operation to give instructions to perform a calibration to the maximum density check processing (step 1201 to step 1204) is the same as that at step 401 to step 404 in the flowchart in FIG. 4 according to the first embodiment.

At step 1205, the controller unit 102 determines whether the density value (jdgD) obtained by the maximum density check processing has changed by an amount equal to or more than a fixed amount from the maximum density target value (tgtMaxD). Details of the density characteristics change determination processing are the same as those explained in the first embodiment by using the flowchart in FIG. 8. In the case where there is no change by an amount equal to or more than a fixed amount for all the toner colors as the determination results, the processing proceeds to step 1206 and the calibration table is created. On the other hand, in the case where there exists a toner color whose change is by an amount equal to or more than a fixed amount, the processing proceeds to step 1207.

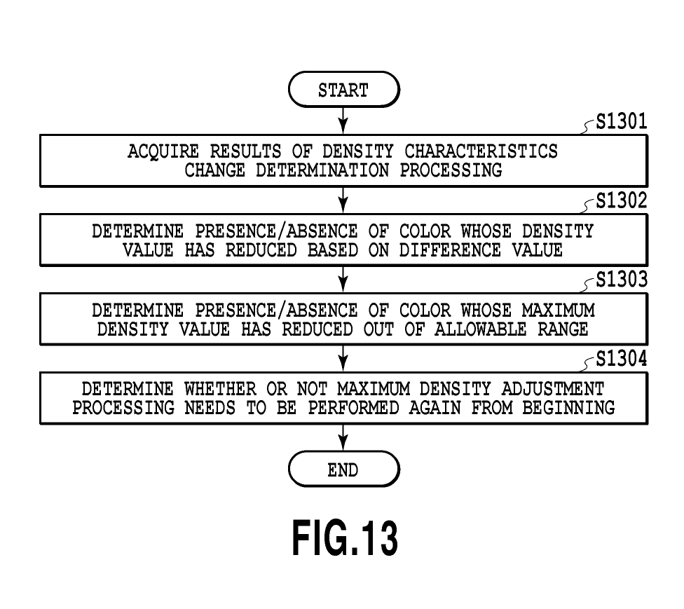

At step 1207, the controller unit 102 performs processing to determine whether the change in the maximum density value by an amount equal to or more than a fixed amount is a change in the direction in which the maximum density value reduces (hereinafter, change direction determination processing). FIG. 13 is a flowchart showing details of the change direction determination processing.

At step 1301, the CPU 105 acquires the results of the density characteristics change determination processing (difcmp) stored in the RAM 107. As described previously, the determination results (difcmp) exist for each toner color and have a value of “1” in the case where the change in density is within the allowable value range and a value of “0” in the case where the change in density is out of the allowable value range.

At step 1302, the CPU 105 specifies a toner color whose maximum density value has reduced. Specifically, by referring to the values of differences (difftgtD) generated and stored in the process of the density characteristics change determination processing, the CPU 105 determines that the maximum density value of a toner color whose value is a positive value has reduced, and sets reduction determination results (dwnD), which exist for each toner color, to 1. The CPU 105 sets the reduction determination results (dwnD) of toner whose maximum density value has not reduced to 0. Then, the reduction determination results (dwnD) are stored in the RAM 107.

At step 1303, the CPU 105 determines the presence/absence of a toner color whose maximum density value has reduced out of the allowable range based on the results (difcmp) of the density characteristics change determination processing and the reduction determination results (dwnD) in the density characteristics change determination processing. Specifically, the CPU 105 finds the number of toner colors (dwncol) whose difcmp and dwnD are “0” and “1”, respectively, and stores the number in the RAM 107. For example, in the case where difcmp and dwnD of cyan and magenta are “0” and “1”, respectively, “2” is set to dwncol and dwncol is stored in the RAM 107.

At step 1304, the CPU 105 determines whether the maximum density adjustment processing needs to be performed again from the beginning based on the value of dwncol described above. Specifically, in the case where dwncol described above is “1” or more, the CPU 105 sets “1” indicating that the maximum density adjustment processing needs to be performed again from the beginning to results (result_dwn) of the present processing and stores result_dwn in the RAM 107. On the other hand, in the case where dwncol described above is “0”, the CPU 105 sets “0” indicating that the maximum density adjustment processing does not need to be performed again from the beginning to the results (result_dwn) of the present processing and stores result_dwn in the RAM 107.

By the above processing, in the case where there is at least one toner color whose maximum density value has reduced to a low value out of the allowable range from the maximum density target value, it means that the maximum density cannot implement the target value, and therefore, it is determined that the maximum density adjustment processing is necessary. Consequently, the processing returns to step 1201 and the maximum density adjustment processing is performed again from the beginning as a result.

On the other hand, in the case where there is not at all such a toner color, the processing proceeds to step 1208 and a calibration table is created as a result.

Explanation is returned to the flowchart in FIG. 12.

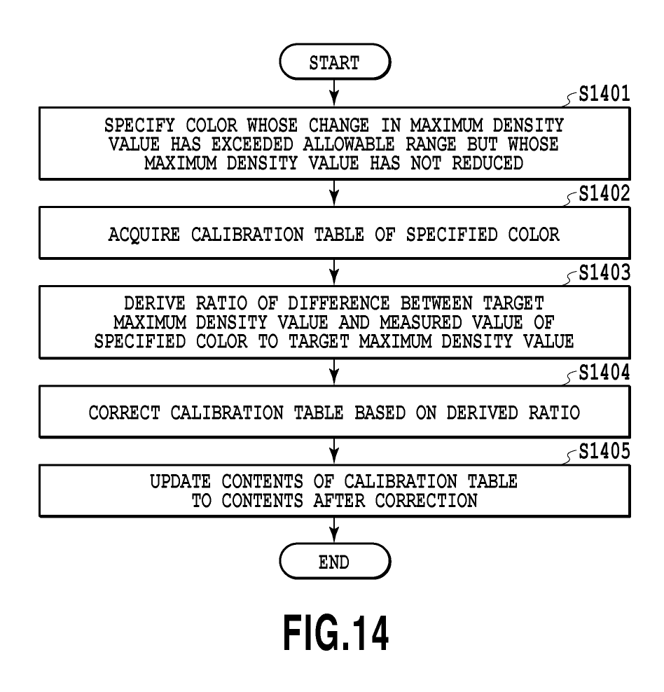

After a calibration table is created at step 1208, the controller unit 102 performs processing to correct the created calibration table at step 1209. FIG. 14 is a flowchart showing details of the calibration table correction processing.

At step 1401, the CPU 105 specifies a toner color for which it is determined that the change in the maximum density value has exceeded the allowable value and the maximum density value has not reduced (a color for which a density value greater than the target maximum density value has been measured and whose change in the density characteristics is large). Specifically, a color having “0” for both the results (difcmp) of the density characteristics change determination processing and the reduction determination results (dwnD) in the density characteristics change determination processing is specified.

At step 1402, the CPU 105 acquires the calibration table (calLUT) of the color specified at step 1401 from the calibration tables (calLUT) created at step 1208.

At step 1403, the CPU 105 finds a ratio of the difference between the target maximum density value (tgtMaxD) and the measured density value (jdgD) in the specified color to the target maximum density value (tgtMaxD). This ratio (diffRatio) is found by an expression (1) below.

diffRatio=(tgtMaxD−jdgD)/tgtMaxD expression (1)

The ratio that is found by the above-describe expression (1) is stored in the RAM 107.

At step 1404, the CPU 105 corrects the calibration table (calLUT) acquired at step 1402 based on the derived ratio (diffRatio). The correction here is processing to reduce the output gradation value of the calibration table (calLUT) by a value corresponding to the ratio (diffRatio) that has been found. The corrected calibration table (calLUT-af) can be obtained by an expression (2) below.

calLUT-af=(1−diffRatio)×calLUT expression (2)

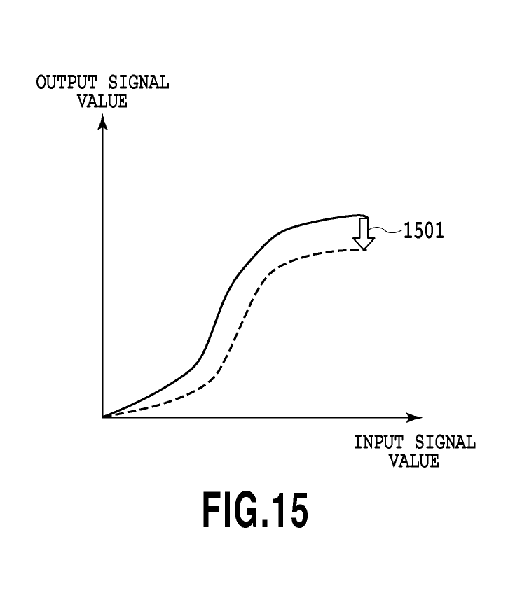

FIG. 15 is a graph indicating the relationship between the calibration table (calLUT) before the correction and the calibration table (calLUT-af) after the correction. In FIG. 15, the horizontal axis represents the input gradation value and the vertical axis represents the output gradation value, and the solid line indicates the characteristics of the calibration table (calLUT) and the dotted line indicates the characteristics of the calibration table (calLUT-af) after the correction. From the graph in FIG. 15, it is known that the calibration table (calLUT-af) after the correction is obtained by shifting the output gradation values of the calibration table (calLUT) in a fixed ratio (diffRatio) in the direction of an arrow 1501.

At step 1405, the CPU 105 updates the calibration table (calLUT) by overwriting the values of the corrected calibration table (calLUT-af) on the values of the original calibration table (calLUT). The updated calibration table (calLUT) is stored in the RAM 107.

The above is the contents of the calibration table correction processing.

Explanation is returned to the flowchart in FIG. 12.

At step 1210, the controller unit 102 stores the calibration tables in the number corresponding to the number of toner colors stored in the RAM 107 in the HDD 120 and brings about a state where the 1D-LUT correction unit 202 can use the calibration tables.

According to the present embodiment, even in the case where the density characteristics have changed after the chart is output, the maximum density adjustment processing is not performed again from the beginning on a condition that the change can be dealt with by correcting the calibration table, and therefore, it is made possible to reduce the downtime of the image forming apparatus while guaranteeing the image quality equal to or higher than a fixed quality.

Further, it is also possible to combine the second embodiment and the third embodiment. In other words, such an embodiment may be accepted, in which only in the case where the possibility of the change in the density characteristics is equal to or more than a fixed value, the maximum density check is performed and further, even in the case where the change in the density characteristics by an amount equal to or more than a fixed amount is recognized, on a condition that the change can be dealt with by correcting the calibration table, the maximum density adjustment processing is not performed again from the beginning. Due to this, it is possible to implement a further reduction in downtime and to suppress a reduction in work efficiency to a minimum.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-261666, filed Dec. 18, 2013, which is hereby incorporated by reference herein in its entirety.

What is claimed is:

1. An image forming apparatus comprising:
a determination unit configured to determine an adjustment value for outputting a maximum density value determined in advance for a color used in forming an image by an image forming unit;
an output unit configured to output a patch image by using an adjustment value determined by the determination unit;
a creation unit configured to create a table for correcting a density value of an image formed by the image forming unit by using the results of measuring a patch image output by the output unit; and
a control unit configured to control, before the creation unit creates a table, whether or not to cause the determination unit to determine the adjustment value again from the beginning in accordance with a difference between the density value of the patch image and the maximum density value by causing the output unit to output the patch image.

2. The image forming apparatus according to claim 1, wherein
in a case where a difference between the density of the patch image and the maximum density value is larger than a threshold value, the control unit performs control to cause the determination unit to determine an adjustment value again from the beginning.

3. The image forming apparatus according to claim 1, wherein
in a case where a difference between the density of the patch image and the maximum density value is smaller than a threshold value, the control unit performs control to cause the creation unit to create a table without causing the determination unit to determine an adjustment value again from the beginning.

4. The image forming apparatus according to claim 1, further comprising a change possibility determination unit configured to determine a possibility of a change in density characteristics, wherein
the control unit performs the control in a case where the change possibility determination unit determines that there is a possibility of a change in density characteristics.

5. The image forming apparatus according to claim 4, wherein
the change possibility determination unit determines a possibility of a change in density characteristics based on at least one factor of a number of sheets on which printing processing has been performed, an elapsed time, an amount of consumed toner, and temperature and humidity around the image forming apparatus.

6. The image forming apparatus according to claim 4, wherein
the change possibility determination unit acquires data used as a reference at the time of determining a possibility of a change in density characteristics for the factor after an adjustment value is determined by the determination unit and determines that there is a possibility of a change in density characteristics in a case where the amount of the change in the factor corresponding to the acquired data exceeds an allowable range determined in advance.

7. The image forming apparatus according to claim 1, wherein
the control unit causes the determination unit to determine an adjustment value again from the beginning in a case where a difference between the density value of the patch image and the maximum density value is larger than a threshold value and it is determined that the maximum density value is greater than the density value of the patch image.

8. The image forming apparatus according to claim 1, further comprising a correction unit configured to correct an output gradation value in a table created by the creation unit, wherein
the control unit performs control to cause the correction unit to perform the correction in a case where a difference between the density value of the patch image and the maximum density value is greater than a threshold value and it is determined that the maximum density value is smaller than the density value of the patch image.

9. A control method of an image forming apparatus, the method comprising the steps of:
determining an adjustment value for outputting a maximum density value determined in advance for a color used in forming an image by an image forming unit;
outputting a patch image by using the determined adjustment value;
creating a table for correcting a density value of an image formed by the image forming unit by using the results of measuring the output patch image; and
performing control, before a table is created in the creation step, whether or not to determine the adjustment value again from the beginning in the determination step in accordance with a difference between the density value of the patch image and the maximum density value by outputting the patch image in the output step.

10. A non-transitory computer readable storage medium storing a program for causing a computer to perform the method according to claim 9.
